(19) United States
(12) Patent Application Publication
(10) Pub. No.: US 2022/0112742 A1
(43) Pub. Date: Apr. 14, 2022

(54) Door locking foldable safety trim

(71) Applicant: Rajwan Mohammad Arif, Casa Grande, AZ (US)

(72) Inventor: Rajwan Mohammad Arif, Casa Grande, AZ (US)

(21) Appl. No.: 16/974,134

(22) Filed: Oct. 14, 2020

(51) Int. Cl. E05B 47/00

(52) U.S. Cl. CPC E05B 47/0012; E05B 2047/0056; E05Y 2900/134; E05B 2047/0084; E05B 2047/0053

(57) ABSTRACT

Object of the invention is a door locking foldable safety trim which increases the strength of the door, it ensures a more efficient way to increase safety. The invention has an adjustable button for locking the trim into the desired angle ensuring the proper fitment to secure. With the release button to close and retract back to the closed position completely flushed, thus giving it a natural trim appearance around the door.

### BACKGROUND OF THE INVENTION

The present invention relates to door lock.

Normally, the average door only has a door lock to keep the door secure in place. Which leaves a safety issue of not having most of the door fully secure. To ensure a better safety method of increasing the door strength from being detached. The door locking foldable safety trim provides extending panels from the left, right, and top of the door which extend and retract to hold and secure the door in place from unauthorized access.

### SUMMARY OF THE INVENTION

### Part 1 of 5

The invention will increase the strength of the door and provide a more efficient way to secure it. With many major global issues such as home invasion, which could lead to theft, rape, murder, damage, and harm. The invention provides many safety features to help. According to a United States Department of Justice report, there are over 4,500 home burglaries per day in the United States. The average number of home invasions per year was 1,030,000 between 1994 and 2010. The 38% of assaults & rape occur during home invasions. Over 2,000,000 homes will experience a break in or burglary this year. The average door only consists of a door knob with a lock to hold the door in place from unauthorized access but has several weak points such as the top, left, and right sides of the door. Which penetrating through the door is not as difficult with enough force generated with one single kick. The invention will replace the original trim around the door frame from the basic wooden trim to the door locking foldable safety trim. The invention has five foldable retracting panels which secure the door from the left, right, and top sides of the door. Pressure impact sensors to detect excessive force onto the door, triggering the safety alarm and locking in place to keep door secured from unauthorized access. Having multiple options on programming to set preferable settings.

### SUMMARY OF THE INVENTION

### Part 2 of 5

The invention will help in the effort for home safety the NFPA Research reported fire departments responded to an estimated average of 355,400 homes fires per year during 2012-2016. Smoke alarms, including those in fires too small to. Reported almost three out of five homes fives deaths resulted from fire in properties with no 40% or not working 17% smoke alarms. When smoke alarms were present in fires considered large enough to active them, they operated in 88% of the reported fires 71% of the deaths and 81% of the injuries. Causes of smoke failure during 2012-2016, fire departments responded to an estimated average of 25,700 home fire per year in which smoke alarms, should have operated but failed to do so, these fires caused an average of 440 deaths and 1,440 injuries annually. When smoke alarms failed to operate, it was typically because of disconnected power source, such as battery problems were most common.

### SUMMARY OF THE INVENTION

### Part 3 of 5

The invention has a smoke detector built in which is automatically activated with red LED lighting which is flashing all throughout the inner side of the panels indicating emergency and visually showing the door as the exit. The invention provides multiple safety benefits of example from animals invading into the home. In many incidents bears have been known to break down doors and enter homes by force. Homes in regions with terrains with mountains usually are effected by breach forced entry. The invention has the ability to detect animals with a sensor triggering an alarm which scares the animal with different tones of sound. Once the door locking foldable safety trim detects excessive force the foldable panels retract onto the door locked in place strengthening the door from impact. With the invention mounted onto the door frame trim with 32 individual screws provides a safe secured placement giving the proper safety.

### SUMMARY OF THE INVENTION

### Part 4 of 5

The invention has the ability to automatically open and close the door using a motorized hinge connected to any of the six power unit panels available depending on design of door. The system runs 24/7 even connecting with the main back up battery in case of power outage, thus putting the invention in emergency mode, turning the LED lighting to red indicating emergency. The motorized hinge is built to replace the standard hinge for any of mounting points depending on the weight of the door and material it consists of and design. The door has a timer to detect the amount of time the door is left open for example, you are on the phone and you go outside suddenly and forget to close the door, you forget the ac unit might be running letting out excessive amount of cold air outside. The door locking foldable safety trim will enable the motorized hinge to engage to the set close position programmed automatically, to several positions as soft close for auto close slowly to only about several millimeters from closing completely. The hinge will slow down the speed of rotational force and recycling the energy back into the battery storage pack. This will help in the effort to slow down the speed of rotational force which leads to excessive damage to walls and the door. The hinge will replace the standard hinge with the motorized hinge with the door locking foldable safety trim.

### SUMMARY OF THE INVENTION

### Part 5 of 5

With issues such as visual lighting at night inside your home the invention has the ability to become a nightlight to help with visual issues at night. The system is eco-friendly and using least amount of energy from the electric power unit. The user has the ability to set preferred lighting colors, rather they choose to increase or dim the light. With multiple door locking foldable safety trims in one place, user may connect with others to set full control lighting at once.

### BRIEF DESCRIPTION OF THE DRAWINGS

### Part 1 of 6

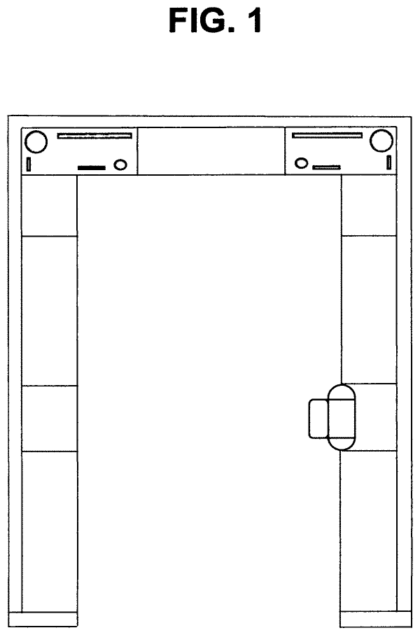

FIG. 1 shows general front view layout of the door locking foldable safety trim in black & white. The invention is shown in the closed position when locking is not required, giving a flush appearance against the wall.

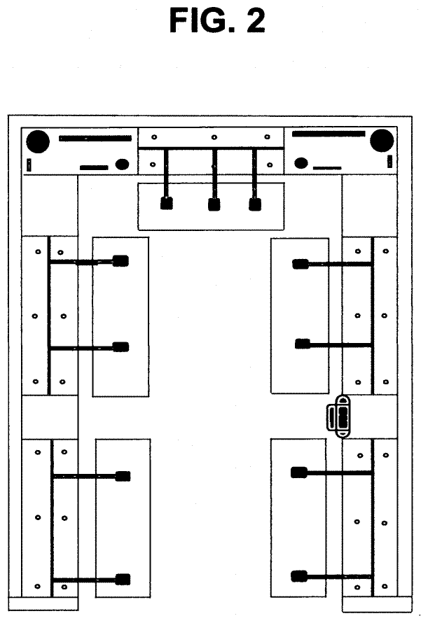

FIG. 2 shows use of invention providing the secure position with the panels retracted. Shown in black & white, the motorized hinge, the foldable panels and the whole unit of the system.

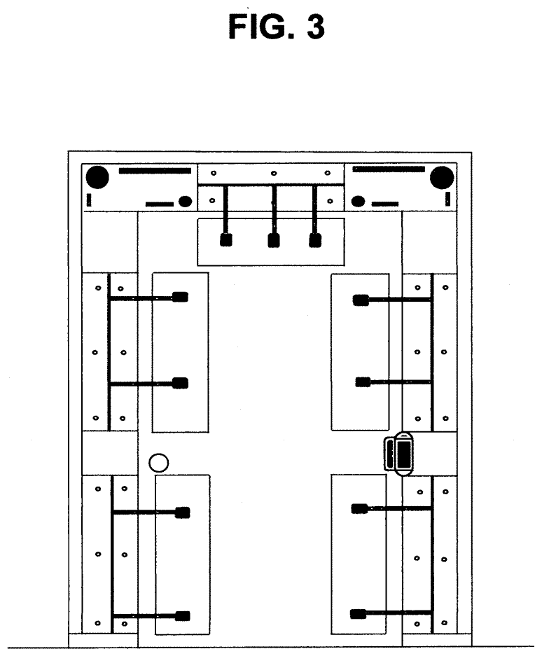

FIG. 3 shows use of invention fixed directly onto the door frame trim providing the secure position with the panels retracted strengthening the door & the motorized hinge to provide a secondary safety option of emergency lock which locks the motorized hinge from retracting, thus locking the door from the opposite side, increasing the strength of the door.

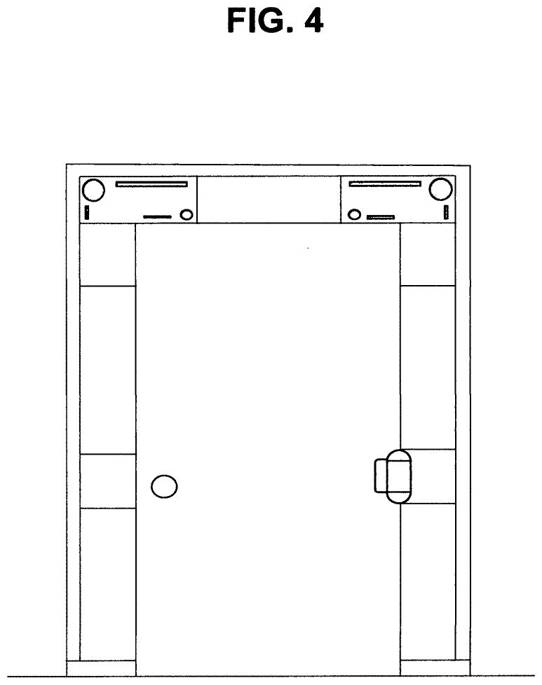

FIG. 4 shows use of the invention in the closed position with the motorized hinge. The invention is shown in black & white. The invention has multiple sensors to detect from fire, animals, excessive pressure against the door.

### BRIEF DESCRIPTION OF THE DRAWINGS

### Part 2 of 6

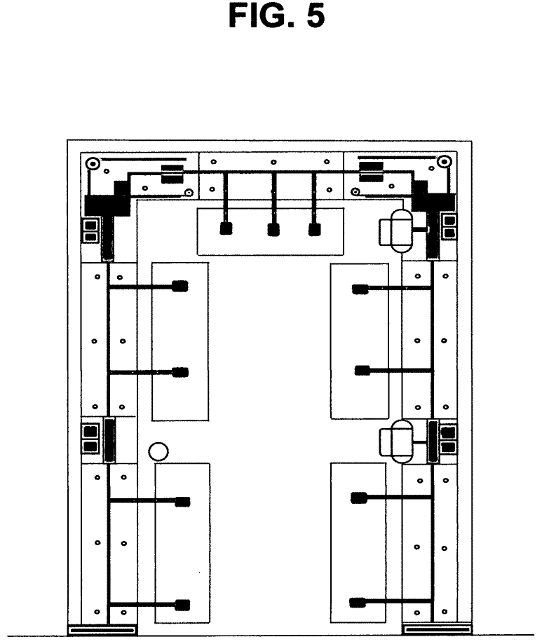

FIG. 5 shows use of invention fixed directly onto the door frame trim providing the secure position with the panels retracted and panel covers removed showing most of the structural components.

The invention shows:
1. Panels Retracted onto door in secured position.
2. Two motorized hinges are connected onto door—only if door exceeds against weight
3. 34 mounting points are shown to secure invention onto the wall around the door frame removing the traditional standard wooden trim.
4. Two smoke detectors
5. Battery Backup Storage
6. Main power unit
7. Two power outlets
8. Sensor
9. Speaker
10. Multiple rotating cylinder housings
11. 12 Connecting Brackets
12. Multiple Electric Motors
13. LED Lighting
14. Wiring Panel
15. 12 Hinges

### BRIEF DESCRIPTION OF THE DRAWINGS

### Part 3 of 6

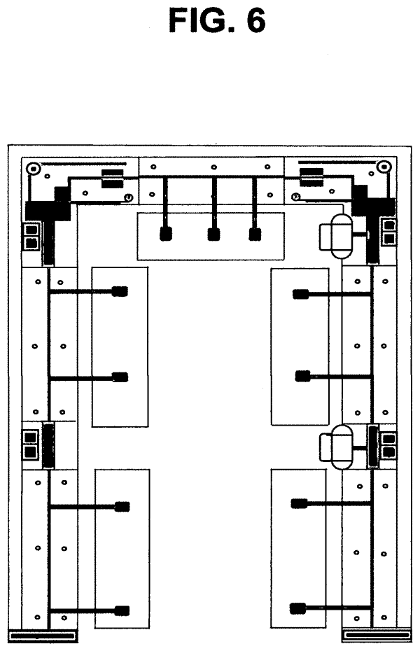

FIG. 6 shows use of invention providing the secure position with the panels retracted in black & white.

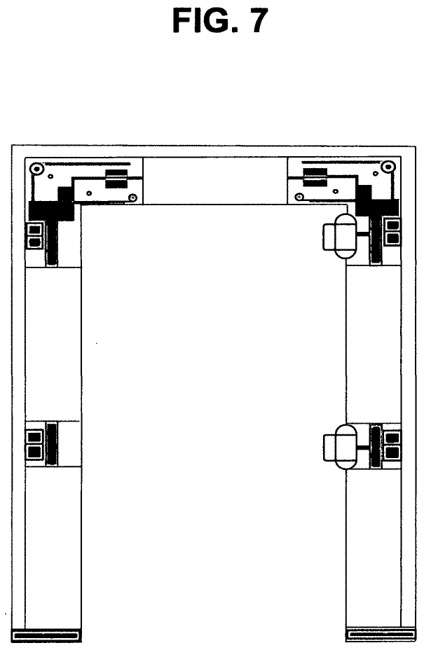

FIG. 7 shows invention in closed position with control panels opened. The invention shows multiple power outlets, if user wants direct power with using retracting plug for power. The invention has the option to remove motorized hinge by disconnecting the plug from the power outlet.

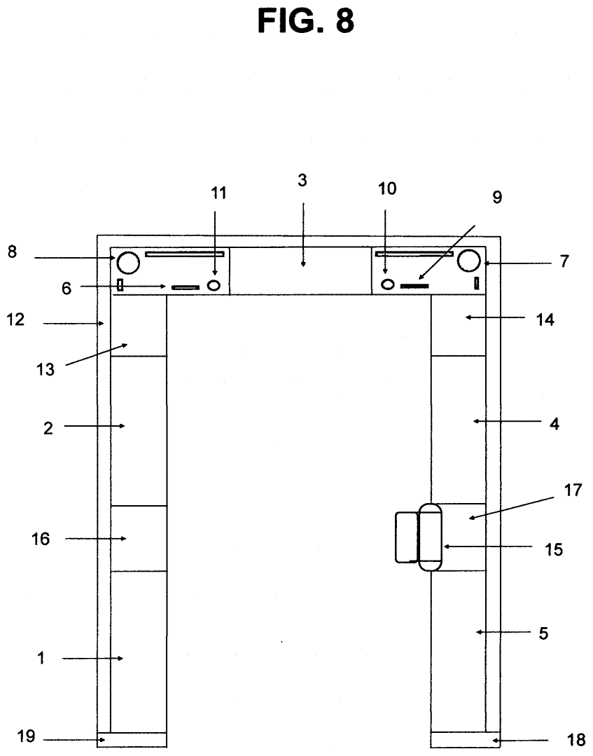

FIG. 8 shows invention in closed position with the motorized hinge. The invention shows numbered arrows indicating each component on the invention from 1-19.

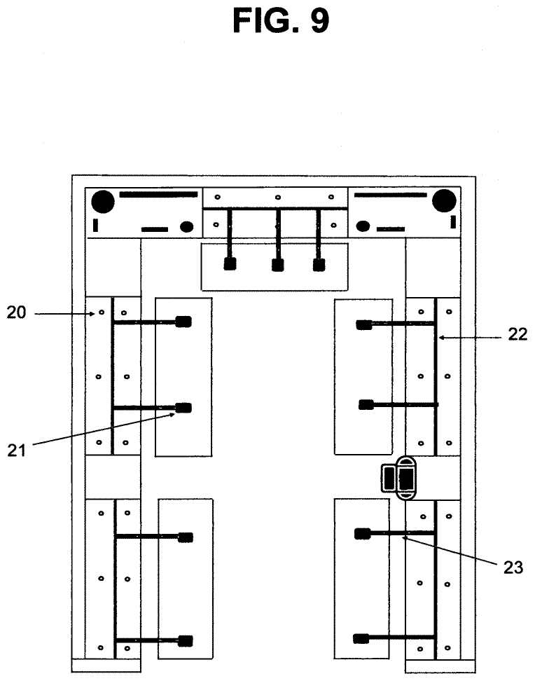

FIG. 9 shows invention in secured position with the motorized hinge in black & white. The image shows numbered arrows indicating each component from 20-23.

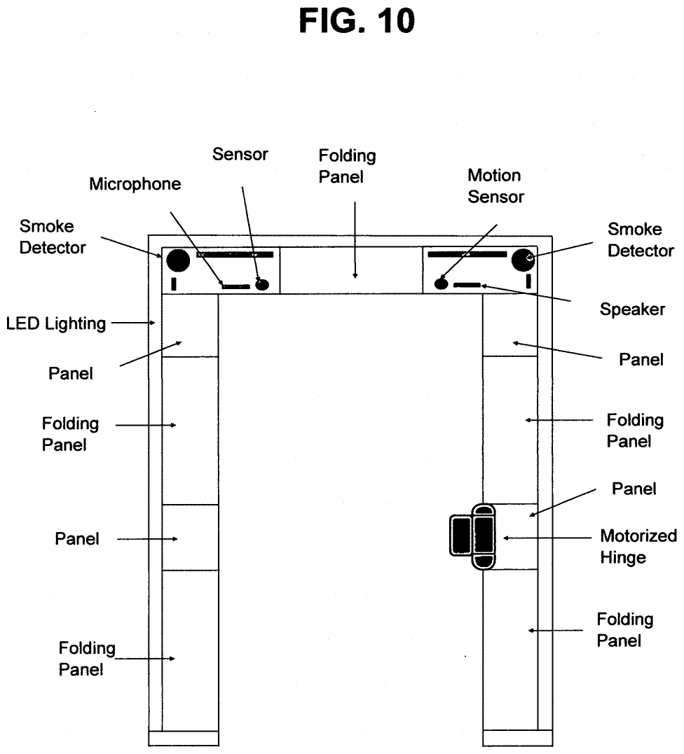

FIG. 10 shows invention in closed position with detailed information for each labeled component. The invention is shown in black & white.

### BRIEF DESCRIPTION OF THE DRAWINGS

### Part 4 of 6

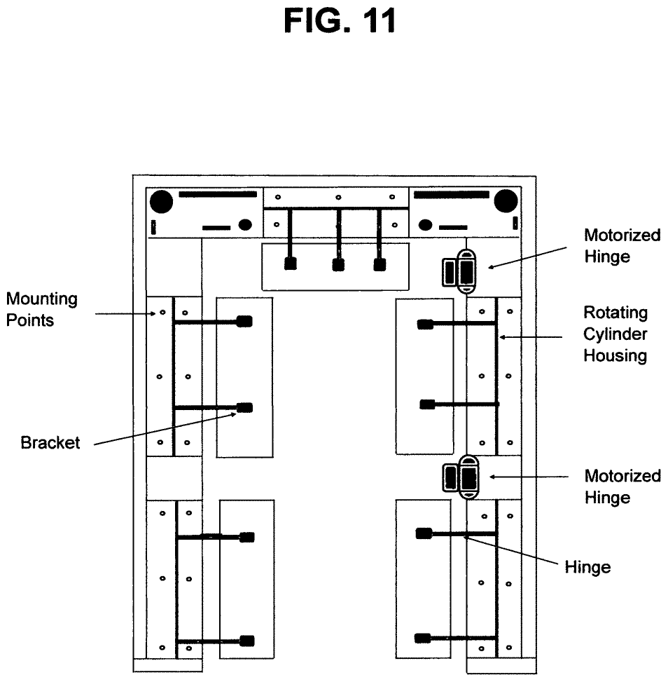

FIG. 11 shows invention in secured position with two motorized hinges. The image shows detailed information on each component with an arrow indicating placement.

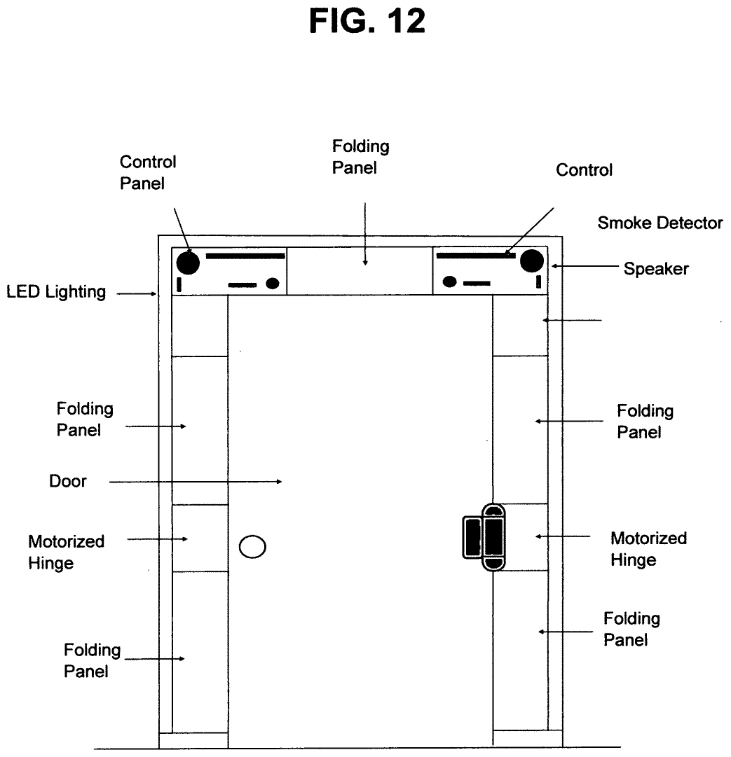

FIG. 12 shows invention in closed position on the door with one motorized hinge connect with door and frame providing multiple safety features. The image shows detailed information about each component. The invention strengthens the door and acts as a safety tool from unauthorized invaders and emergency alert system.

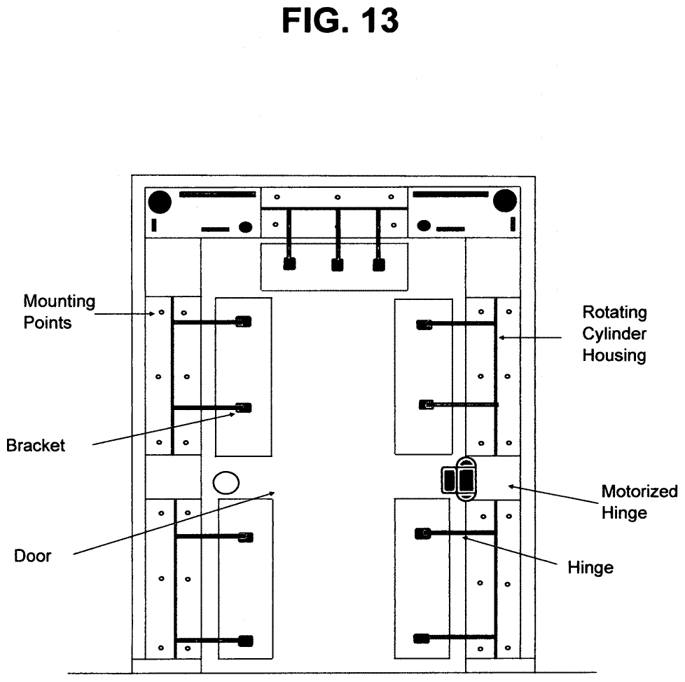

FIG. 13 shows invention in secured position on the door with detailed information about
1. hinges
2. mounting points
3. securing door from inside home
4. motorized hinge turned to freeze-mode locking the hinge until released
5. rotating cylinder housing pipes
6. brackets connecting to panels

### BRIEF DESCRIPTION OF THE DRAWINGS

### Part 5 of 6

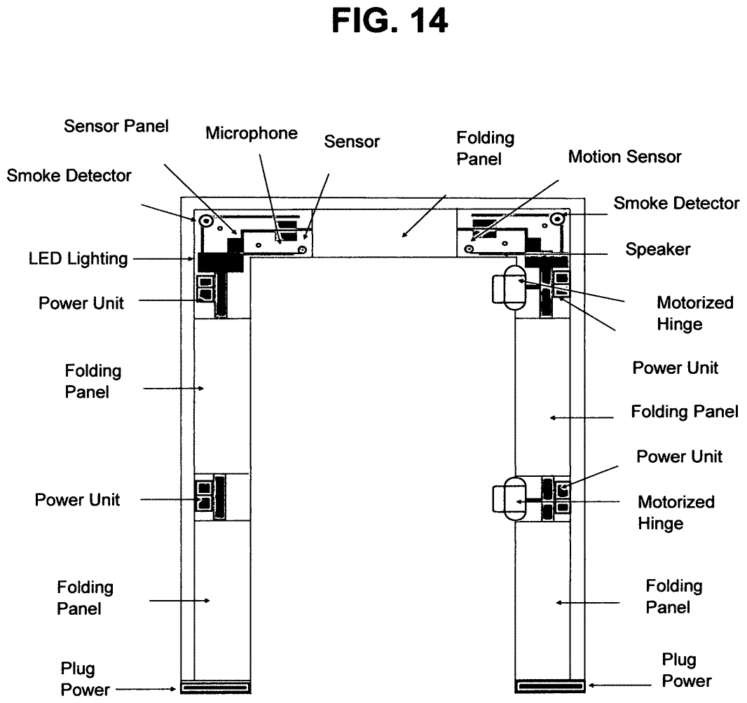

FIG. 14 shows invention in closed position on the door with the control panels off with detailed information.
1. Smoke detectors
2. Speaker
3. Microphone
4. Power Units
5. Motorized Hinges
6. Motion Sensor
7. Sensor Panel
8. Folding Panels
9. Plug Power

### BRIEF DESCRIPTION OF THE DRAWINGS

### Part 6 of 6

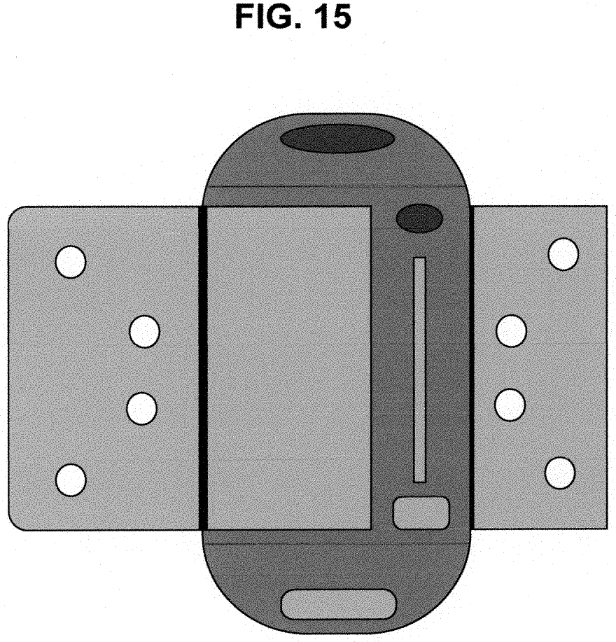

FIG. 15 shows the motorized hinge, general close up view of the motorized hinge. The motorized hinge was developed specially to replace the standard door hinge to provide rotational force resistant with self auto closing.

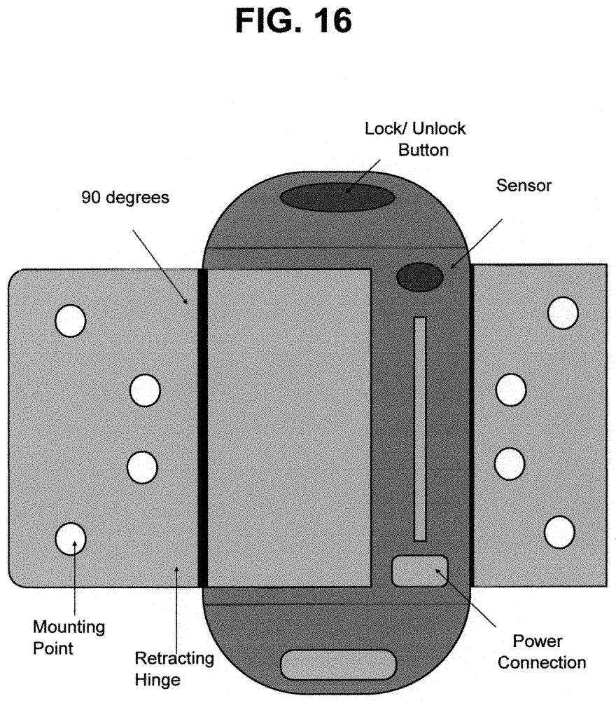

FIG. 16 show the motorized hinge in black & white. The image shows detailed information regarding each component on the motorized hinge with arrows indicating placement as well. The motorized hinge has a push button lock mechanism to lock and release for secondary locking measures.

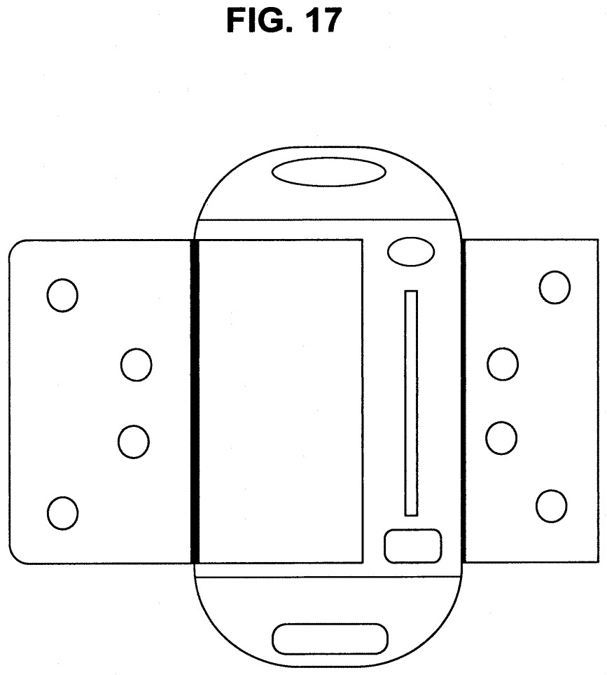

FIG. 17 shows the motorized hinge in black & white. The motorized hinge is easy to install. For example, standard door with three hinges. User will replace middle hinge with the new motorized hinge with the door locking foldable safety trim. The motorized hinge will provide an better solution to increase strength and safety. The idea came to mind when multiple issues are visible with a standard door. Even though the door is locked is it still weak in many angles. The motorized hinge with the whole unit of the door locking foldable safety trim will provide an alternate solution to increase the safety of unauthorized breach.

### DETAILED DESCRIPTION OF THE DRAWINGS

### Part 1 of 9

FIG. 1 shows general front view layout of the door locking foldable safety trim in black & white. The invention has many safety features as:
1. Smoke Detectors
2. Motion Sensor to engage self close
3. Panel Covers
4. Motorized hinge
5. LED Lighting
6. Speaker
7. Microphone

### DETAILED DESCRIPTION OF THE DRAWINGS

### Part 2 of 9

FIG. 2
1. shows a front view layout of the of the door locking foldable safety trim.
2. Shows Smoke Detector
3. Speaker for user interface providing sound.
4. Panels retracted to securing position
5. 30 Mounting points are shown out of 34 Mounting points
6. 11 brackets are shown
7. 5 folding panels are shown
8. 5 Rotating Cylinder Housing Pipes are shown

### DETAILED DESCRIPTION OF THE DRAWINGS

### Part 3 of 9

FIG. 3 shows invention is fixed onto the door trim door showing general placement on the invention retracted into the secure position.

The image shown on FIG. 3 shows invention in black & white. The invention shows how user positioned in the secure position with the panels retracted onto door. The panels retract within seconds for instant contact.

FIG. 4 shows invention retracted into the closed position around the door in black & white. The invention is set to closed position giving the flush appearance around the door, since the invention will replace the traditional wooden trim. The invention is composed of many strong materials from metals, carbon fiber, rubber, plastics. Giving the whole unit a rigid structural skeleton to provide maximum strength.

### DETAILED DESCRIPTION OF THE DRAWINGS

### Part 4 of 9

FIG. 5 shows use of invention fixed directly onto the door frame trim providing the secure position with the panels retracted. the image shows the invention has all the panels removed exposing all of components from:
1. Speaker
2. Microphone
3. Battery Backup
4. Power Unit
5. Control Board
6. Motion Sensor
7. Two Motorized Hinges
8. Sensor
9. Electric Motor
10. Keypad
11. Wiring Housing
12. Mother Board
13. Inside view facing door from home

### DETAILED DESCRIPTION OF THE DRAWINGS

### Part 5 of 9

FIG. 6 shows use of invention in the secure position with the panels retracted. The invention shows many components from the panels to the brackets connecting them with the rotating cylinder housing pipes giving consistent movement to work all at the same time ensures the proper frequent motion.

FIG. 7 shows invention in closed position with control panels opened. The invention shows two motorized hinges attached to the power unit for 24/7 power to run at full capacity, also noted backed up by a backup battery in case of power outage the invention will go into emergency alert mode, turning on the LED lighting into red signaling as if it is an emergency exit. The invention will help decrease fire hazard issues due to low visibility, the invention will provide an emergency tool to give visual appearance of an emergency exit when visibility is low inside a home due to fire smoke and not being able to see the exits or hear, the invention has multiple smoke detectors with speaker to project tones to signal alert.

### DETAILED DESCRIPTION OF THE DRAWINGS

### Part 6 of 9

FIG. 8 shows invention in closed position with numbered arrows from 1 to 19 showing each component in black & white.

FIG. 9 shows invention in secured position with numbered arrows from 20-23 showing position of each component in black & white. The folding panels retract quickly and secure in position with a quick release button to set to closed position.

FIG. 10 shows invention in closed position with detailed information such as:
1. Smoke detectors
2. Speaker
3. Microphone
4. Power Units
5. Motorized Hinges
6. Motion Sensor
7. Sensor Panel
8. Folding Panels

### DETAILED DESCRIPTION OF THE DRAWINGS

### Part 7 of 9

FIG. 11 shows invention in secured position with detailed information such as:
1. Motorized Hinges
2. Brackets
3. Rotating Cylinder Housing Pipes
4. Mounting Points

FIG. 12 shows invention in closed position on the door with detailed information. The image shows the invention components.

FIG. 13 shows invention in secured position on the door with detailed information.
1. hinges
2. mounting points
3. securing door
4. motorized hinge
5. rotating cylinder housing pipes
6. brackets connecting to panels

### DETAILED DESCRIPTION OF THE DRAWINGS

### Part 8 of 9

FIG. 14 shows invention in closed position on the door with the control panels off with detailed information such as:
1. Smoke detectors
2. Speaker
3. Microphone
4. Power Units
5. Motorized Hinges
6. Motion Sensor
7. Sensor Panel
8. Folding Panels
9. Plug Power

### DETAILED DESCRIPTION OF THE DRAWINGS

### Part 9 of 9

FIG. 15 shows the motorized hinge in black & white. The hinge has many features giving the whole invention many options for the user to set for auto close, soft close, set times, command open/close.

FIG. 16 shows the motorized hinge front view in black & white. The motorized hinge is labeled with detailed information about the components the motorized hinge consist of. The invention has many safety features from damage to walls. Door are often open and shut quite aggressively as well by children and high winds the specially engineered motorized hinge will prevent damage to walls and the door itself.
1. Retrating hinge
2. Sensor
3. Power Outlet Connector
4. Lock/Release Button

FIG. 17 shows the motorized hinge with the general view in black & white. The motorized hinge will provide so many benefits especially in homes.

1. The door locking foldable safety trim composes of many components giving the ability to retract back and forth onto the door from left, right, and top angles using foldable panels.

2. The invention has the ability to project lighting from the left, right, and top of the door using LED lighting mounted directly around the trim.

3. The ability to connect via device applications interfaced with user for unlocking and locking.

4. The invention has a motorized hinge enabling the door to shut and open automatically, replacing the standard traditional door hinge.

5. The door locking foldable safety trim has the ability to automatically fold and retract back to closed position with connected portable key sensor.

6. The door locking foldable safety trim has the ability to automatically fold and retract back to closed position with connected smart door knob.

7. The invention has the ability to detect smoke, thus folding back to the closed position. Providing a red flashing light till sensor is cleared.
